(19) United States
(12) Patent Application Publication
(10) Pub. No.: US 2018/0082039 A1
(43) Pub. Date: Mar. 22, 2018

(54) PRESCRIPTION DISPENSING SYSTEM AND METHOD OF OPERATION

(71) Applicant: IA Health Solutions, Inc., Lexington, MA (US)

(72) Inventors: Adam Hesse, Lexington, MA (US); Matthew R. Eisendrath, Lexington, MA (US)

(21) Appl. No.: 15/711,673

(22) Filed: Sep. 21, 2017

Related U.S. Application Data
(60) Provisional application No. 62/397,621, filed on Sep. 21, 2016.

(51) Int. Cl. G06F 19/00

(52) U.S. Cl. CPC G06F 19/3462; G06F 21/31

(57) ABSTRACT

A pill dispenser management system includes a communication network-based computing device to receive a pharmacy claim from a healthcare provider computing device in which the pharmacy claim associated with a prescription to be fulfilled by a pharmacy for a patient, and process the received pharmacy claim to generate a pharmacy plan that includes information associated with the prescription. The computing device then transmits the prescription information to a pharmacy computing device so that the pharmacy associated with the pharmacy computing device generates the prescription according to the pharmacy claim and provides the prescription to the patient. When prescription identifying information is received from a pill dispenser computing device of a pill dispenser, compare the prescription identifying information with the pharmacy plan to ensure that the prescription that is loaded in the pill dispenser is proper. Thereafter, the pill dispenser computing device of the pill dispenser monitors the prescription plan and generates a notification message to the patient when a dose of the prescription is needed for the patient.

### CROSS REFERENCE TO RELATED APPLICATIONS

The present application claims benefit under 35 U.S.C. § 119 of U.S. Provisional Patent Application No. 62/397,621, entitled, “PRESCRIPTION DISPENSING SYSTEM AND METHOD OF OPERATION,” filed Sep. 21, 2016, the entirety of which is incorporated herein by reference.”

### TECHNICAL FIELD

Aspects of the present disclosure relate to computing devices and, in particular, to a pill dispenser system and method of operation.

### BACKGROUND

Outcomes-based healthcare represents a significant shift from the traditional healthcare delivery model. Reimbursement is being tied to outcomes, and treatment decisions are being made based on the ability to support this new model. This model is driving change at multiple levels of the healthcare system, including patient adherence.

In order to judge whether or not a treatment plan is effective, a healthcare provider must be able to confirm whether or not the treatment plan was followed by the patient. If a patient adheres to a given treatment plan, the effectiveness can be measured, and under the new model, is tied to reimbursement. Healthcare providers are motivated to ensure that their treatments are optimal, and now health care insurance companies and insurance providers (also referred to herein as “payers”) are using this data to decide reimbursement levels.

Beyond the payer and care provider, pharmaceutical manufacturers are interested in ensuring the maximum effectiveness of their products. In certain disease states and for specific drugs, pharmaceutical manufacturers are reimbursed based on the effectiveness of their drugs, and tracking adherence to a pharmacy regimen as administered to patients is often required to accurately measure effectiveness.

### SUMMARY

According to one aspect of the present disclosure, a pill dispenser management system includes a communication network-based computing device to receive a pharmacy claim from a healthcare provider computing device in which the pharmacy claim associated with a prescription to be fulfilled by a pharmacy for a patient, and process the received pharmacy claim to generate a pharmacy plan that includes information associated with the prescription. The computing device then transmits the prescription information to a pharmacy computing device so that the pharmacy associated with the pharmacy computing device generates the prescription according to the pharmacy claim and provides the prescription to the patient. When prescription identifying information is received from a pill dispenser computing device of a pill dispenser, compare the prescription identifying information with the pharmacy plan to ensure that the prescription that is loaded in the pill dispenser is proper. Thereafter, the pill dispenser computing device of the pill dispenser monitors the prescription plan and generates a notification message to the patient when a dose of the prescription is needed for the patient.

### BRIEF DESCRIPTION OF THE DRAWINGS

The various features and advantages of the technology of the present disclosure will be apparent from the following description of particular embodiments of those technologies, as illustrated in the accompanying drawings. It should be noted that the drawings are not necessarily to scale; however the emphasis instead is being placed on illustrating the principles of the technological concepts. Also, in the drawings the like reference characters refer to the same parts throughout the different views. The drawings depict only typical embodiments of the present disclosure and, therefore, are not to be considered limiting in scope

FIG. 1 illustrates an example pill dispenser management system according to one embodiment of the present disclosure.

FIG. 2 illustrates an example process that is performed by the pill dispenser management system according to one embodiment of the present disclosure.

FIG. 3 is a block diagram illustrating an example of a computing device or computer system which may be used in implementing the embodiments of the present disclosure.

### DETAILED DESCRIPTION

As used herein, the term “health care provider” or “care provider” refers to a person or an entity, for example, a medical practitioner, a medical specialist, a health specialist, a physician, a doctor, a dentist, a surgeon, a nurse, a therapist, a nutritionist, a pharmacist, a clinical trial professional, a clinical study professional, a healthcare institution such as a hospital, a clinic, etc., a health maintenance organization, a caregiver, etc., that provides health care services, for example, medical treatment, medical assistance, dental treatment, medications, care assistance, etc., to a patient.

As used herein, the term “caregiver” refers to professional or medically-trained caregivers and non-medical or non-professional caregivers.

As used herein, the term “non-medical caregivers” includes family members or non-family caregivers. Non-family caregivers can include any non-professional or non-medically trained health care provider familiar with the patient's home medication including, without limitation, a patient's acquaintances, neighbors, and volunteers.

As used herein, “patient” refers to a person who receives health care services from a health care provider.

As mentioned previously, adherence to pharmacy regimens as administered to patients are often required to accurately measure or gauge the effectiveness of pharmacy products. Pharmacy adherence programs do exist, but they typically involve tracking of a patient picking up their prescription, rather than actually taking their prescription. Beyond pickup verification, some specialty pharmaceuticals, which are typically very expensive and are treating life critical conditions, are being distributed with mobile and other applications for the patient to track their adherence. Merely picking up the prescription does not verify whether the patient actually takes the medication, and the financial incentives being used are motivating behavior that may not actually be tied to adherence (i.e. offering cash for picking up the prescription may only motivate picking up the prescription). On the other end of the spectrum, interactive mobile applications allow patients to take videos of themselves consuming their prescription as a demonstration to adherence to the pharmacy regimen. These solutions often do not simplify the adherence process; instead, they usually only add administrative overhead to the patient.

Beyond adherence, there is a usability problem in healthcare, particularly for those patients who have complex prescription regimens and the elderly. Pharmacies often offer services to pre-package patient's prescriptions into meal doses, such that the patient needs to take the pills that are packaged in the associated meal packet (e.g. separate packets for breakfast, lunch, and dinner). Failure to take a combination of prescriptions in the appropriate order or schedule may make the patient feel worse, or even cause them to be admitted or re-admitted to a healthcare facility. Even providers that are not measuring outcomes are measuring re-admission rates as a quality metric. Additionally, there are other home use automated pill dispensers on the market, but all need to be programmed by the patient or professional and updated to match changes to their prescriptions.

In the example of pre-packaged meal-based prescriptions, the complexity burden is removed from the patient, but a customized delivery service is required to support the repacking of pills into packets. Patients cannot fill their prescriptions at any retail pharmacy location; all prescriptions must be combined centrally and packaged on specialized equipment. For existing home pill dispensers, the complexity burden still falls to the patient, in that they must to count out their prescriptions into individual containers, or fill bins and program a complicated dispenser. Failure to setup and program the dispenser correctly could result in the patient feeling worse, or being re-admitted to a healthcare facility. In this case, the patient is attempting to use technology to maintain adherence, but if the device is not loaded properly by the patient, there is no warning or quality control step for the patient to realize they are taking the wrong prescription or combination of prescriptions prior to ingestion.

For certain medical conditions (e.g., disease/illness states), there are other smart devices that would connect wirelessly to the pill dispenser to not only track medication adherence, but also collect key vital signs and other measurements. This will provide a more comprehensive data set to help manage and measure not only medication adherence, but also the effectiveness of a certain drug as can be ascertained by certain vital signs such as weight, heart rate, blood pressure, etc.

Lastly, many healthcare facilities, particularly senior care facilities, employ individuals who deliver prescriptions to individual patients who cannot manage their own prescriptions. This manual labor adds significant cost to the healthcare system.

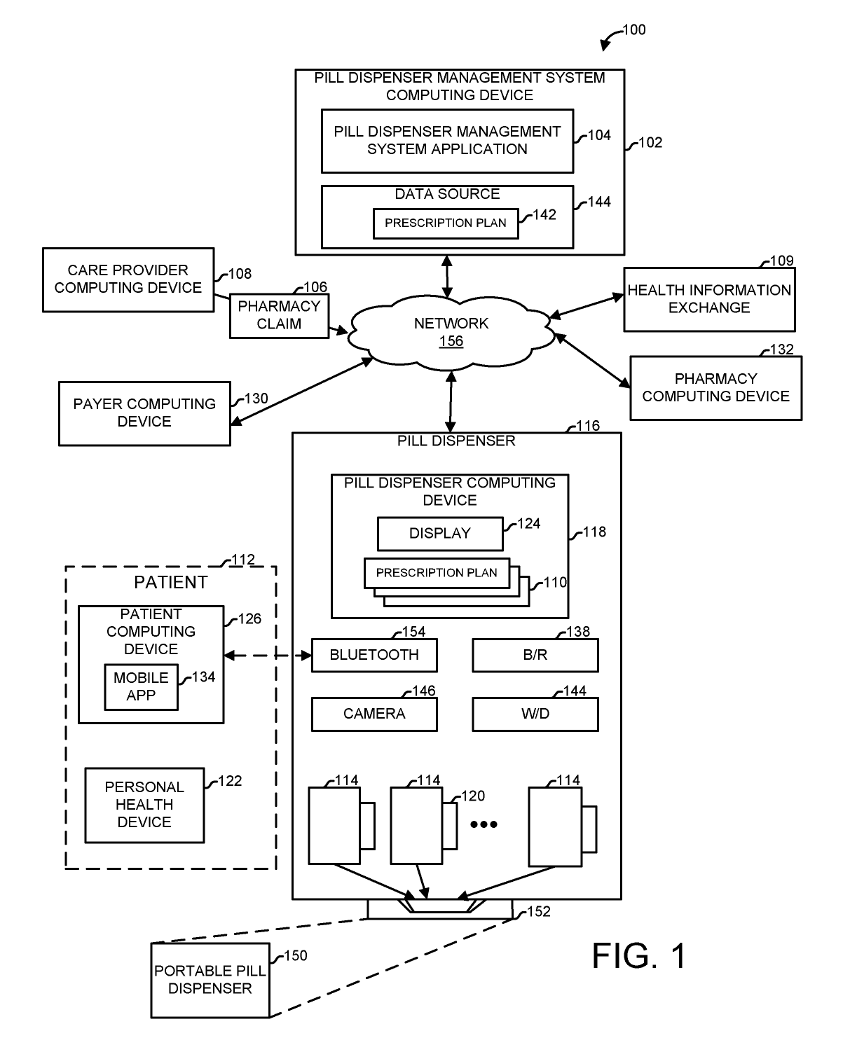

FIG. 1 illustrates an example pill dispenser management system 100 according to one embodiment of the present disclosure. The pill dispenser management system 100 includes a pill dispenser management system computing device 102 having a pill dispenser management application 104 that, when executed, processes a pharmacy claim 106 from a pharmacy management system or health information exchange 109 for generating a prescription plan 142 to be delivered to the pill dispenser computing device 118. The prescription 110 may be added to the pill dispenser 116 in a cartridge or pill bottle that is adapted for insertion in one of multiple receptacles 114 configured in a pill dispenser 116. Given such a configuration, the pill dispenser computing device 118 executes the prescription plan by notifying the user at appropriate intervals as specified by the prescription information contained in the prescription plan 142.

In general, the prescription plan 142 is maintained and updated by the pill dispenser management system 100, while one or more prescriptions 110, which are embodied in the prescription plan 142, will be executed by the pill dispenser 116. The pill dispenser 116 only needs to check with the prescription plan 142 periodically for updated prescription information (e.g., the health care provider desiring to change a dosage of a particular prescription 110).

Although only one prescription 110 and related pharmacy claim 106 are shown and described herein, it should be appreciated that the pill dispenser management application 104 may be adapted to manage as many pharmacy claims 106 and related prescriptions 110 according to the quantity of receptacles 114 in each pill dispenser 116. In one embodiment, ten to fifteen receptacles 114 may be provided in each pill dispenser 116. In other embodiments, less than ten or greater than fifteen receptacles 114 may be provided in each pill dispenser 116.

The application 104 may be configured to manage pharmacy claims 106 and related prescriptions 110 for multiple pill dispensers 116. For example, a pill dispenser 116 may be provided for each of multiple patients of the system 100.

In one embodiment, the system 100 may interface with one or more personal health devices 122 (e.g., blood pressure monitors, body temperature measurement devices, weight scales, glucometers, fitness monitors, etc.) using a Bluetooth® device 154, or other low energy radio-frequency (RF) device, to wirelessly gather additional information relevant to the patient's condition and general health that is communicated to the cloud applications.

In general, upon receipt of a prescription 110, the patient 112 may load a pill bottle that contains the prescription 110 into a receptacle 114 of the pill dispenser 116. The pill dispenser computing device 118 may then read a label on the pill bottle and associate the receptacle 114 to the contents of the prescription 110 to obtain a prescription identifying device 120. The prescription identifying device 120 will be used to associate the prescription collected from the system with the contents of the bottle, and in some cases, additional information available from the National Drug Code (NDC). Based on the pharmacy claim 106, the pill dispenser 116 will automatically notify the patient when it is time to take their prescription(s). In one embodiment, the pill dispenser computing device 118 may generate a visual notification via a display 124 (e.g., liquid crystal display (LCD) screen) coupled to the pill dispenser computing device 118. As another example, the display 124 may include one or more lamps (e.g., light emitting diodes (LEDs)) that are configured on the pill dispenser 116 and programmed to emit a light pattern indicating that it is time for a particular prescription to be taken by the patient.

In another embodiment, the pill dispenser computing device 118 may generate a text message that is delivered to a patient computing device 126 owned and managed by the patient 112. For example, the pill dispenser computing device 118 may generate a text message that will be delivered to a configurable set of phone numbers indicating it is time for the patient to take their prescription(s). In yet another embodiment, the pill dispenser computing device 118 may generate an e-mail message that is delivered to a patient computing device 126 owned and managed by the patient. In a further embodiment, the pill dispenser computing device 118 may generate a voice call that will be made to a configurable set of phone numbers indicating it is time for the patient 112 to take their prescription(s). In another further embodiment, the pill dispenser computing device 118 may generate a mobile application (e.g., a mobile app) alert message that is delivered to a mobile app 134 executed on one of the patient computing devices 126 owned and managed by the patient 112. For example, the pill dispenser computing device 118 may generate a mobile app alert message that will be used by the mobile app 134 to alert the patient 112 that it is time to take their prescription(s).

In yet another embodiment, the pill dispenser computing device 118 may generate an e-mail message, a text message, and/or a phone message that is delivered to a health care provider computing device 108 owned and managed by the health care provider of the patient 112. For example, the pill dispenser computing device 118 may generate a text message, e-mail message, or other method of alerting a health care provider and the health care provider will be prompted to contact the patient, via phone, text, through a family member or other means.

Each of the pill dispenser computing device 118, the health care provider computing device 108, the payer computing device 130, the health information exchange 109, and the pharmacy computing device 132 includes a computing device comprising instructions stored in at least one memory and executed by at least one processor to perform their respective features described herein.

In one embodiment, the system 100 may include an authentication mechanism to ensure that the prescription(s) 110 are administered to the appropriate patient(s) 112. Any suitable type of authentication mechanism may be used. For example, the authentication mechanism may include a biometric reader (B/R) 138 that can be programmed with fingerprint information from the patient 112. Afterwards, the patient 112 may introduce their finger to the biometric reader 138. Based on successful authentication of the patient, the pill dispenser 116 may dispense the appropriate pills, and in the appropriate quantities to satisfy a prescription plan 142 delivered from the application 104 to the pill dispenser computing device 118. Because of the biometric reader, multiple patients will be able to use the same pill dispenser. The prescription plan 142 is stored in a data source 144 of the computing device 102.

In one embodiment, the pill dispenser computing device 118 may include a water dispenser (W/D) 144 for dispensing water from a water source, such as a home water supply line, or internal water reservoir, so that the patient 112 may be provided with a glass of water to consume with their pills.

In one embodiment, the pill dispenser computing device 118 may display images of the pills that have been dispensed, and the quantities of the dispensed pills so that the patient 112 may verify that the dispensed pills and quantity dispensed matches those shown on a display 124. Additionally, the pill dispenser computing device 118 may display instructions associated with the dispensed pills. In some cases, the pill dispenser computing device 118 may also include educational information about the dispensed pills, such as a particular ailment the pills are needed to cure, or other useful information to the patient.

In one embodiment, the pill dispenser 116 may be configured with a camera 146 that records video information, such as one that records the act of taking the dispensed pills by the patient 112 in which such video information may be used by other stakeholders (e.g., the provider, the payer, the pharmacy, other patients, etc.) to verify that the pills were indeed taken.

In one embodiment, the system 100 may include a portable pill dispenser or pillbox 150 that may be used in remote locations. For example, when patients are away from home for any period of time (e.g., vacation, business travel, etc.), it may not be advantageous or feasible to transport the pill dispenser 116 with them. Thus, the portable pill dispenser 150 may be used to administer the prescription 110 for the patient 112 while the patient is away from home for any period of time. In general, the portable pill dispenser 150 includes multiple receptacles, a pill dispenser computing device that performs a function similar to the receptacles 114 and pill dispenser computing device 118 of the pill dispenser 116. The receptacles of the portable pill dispenser 150, however, may be somewhat smaller; that is, they may have a capacity for holding sufficient pills for a certain number of days (e.g., approximately 14 days). The portable pill dispenser 150 may be loaded with pills in any suitable manner. In one embodiment, the pills of the prescription 110 may be manually loaded in the receptacles. In another embodiment, the pill dispenser 116 may be configured with a docking station 152 that can temporarily dock the portable pill dispenser 150 so that the receptacles of the portable pill dispenser 150 may be automatically dispensed from the receptacles 114 of the pill dispenser 116 to respective receptacles of the portable pill dispenser 150. In some cases, the portable pill dispenser 150 may be configured with a Bluetooth® transceiver or other low energy radio-frequency (RF) device that communicates with the patient computing device 126 (e.g., a mobile phone) to display notifications to the patient, and/or prescription information to the patient 112 via the patient computing device 126. Additionally, the Bluetooth® transceiver may be used to receive feedback information from the patient regarding their physical or mental state as feedback about the effects of each dose. This feedback will be in the form of enumerated values and any notes that the patient elects to enter. Feedback can be entered directly into the pill dispenser or a companion mobile application; additionally, the patient may choose to provide a video log using the pill dispenser or mobile device's built-in camera.

Information about the timing of doses (relative to the planned time) and feedback about the effect of each dose will be stored and managed by the application 104. As such, patients and/or care providers can review the patient's dosage history at any time and manipulate or analyze this data through provided analytics tools or export the information to other systems as they prefer.

The application 104 may calculate adherence scores to measure a patient's adherence to the prescription plan, which can be reviewed by the provider and/or payer. Additionally, the application 104 may identify certain health habits that the patient can choose to follow, and by doing so, the patient can improve their adherence score. The adherence score can be leveraged to earn rewards for the patient. Adherence scoring can include not just adherence input, but also measurements taken with vital signs measurement device to provide a more holistic understanding of patient health.

The adherence score may provide value to the provider and payer in multiple ways. It can be used to identify when intervention is necessary, and predictive analytics may provide insight into future risks. For example, a non-adherent patient in a specific disease state will likely cost more in the coming year and have specific complications.

Based on the feedback, the physician may choose to modify the prescription plan using the application 104 via a user interface (e.g., a web browser) provided on the provider computing device 108. Such intervention may be useful to avoid or mitigate a potentially more costly and harmful event from occurring. Any modifications to the prescription plan 142 may be immediately transmitted to the pill dispenser 116 so that the change may be immediately available to the patient 112. In most cases, this adjustment to the prescription plan 142 may not require significant behavior modification by the patient, and may be recorded as part of the patient's record. Additionally, appropriate individuals will be electronically notified (e.g. the patient via the patient computing device 126, the care provider via the care provider computing device 108, the payer via the payer computing device 130, etc.). Additionally, as pill quantities reach a minimum threshold, based on the condition of the patient (e.g., illness, disease state, etc.), prescription plan, and/or receptacle 114 level, the application 104 may automatically reorder additional pills, or notify the patient and/or health care provider to reorder the prescription via the patient computing device 126 and/or health care provider computing device 108, respectively.

The computing device 102, health care provider computing device 108, payer computing device 130, pharmacy computing device 132, and pill dispenser computing device 118 communicate with one another in any suitable manner. For example, the computing device 102, health care provider computing device 108, payer computing device 130, pharmacy computing device 132, and pill dispenser computing device 118 communicate with each other using a communication network 156, such as a wireless and/or wireline communications (e.g., the Internet, an intranet, or another wired and/or wireless communication network). In one embodiment, computing device 102, health care provider computing device 108, payer computing device 130, pharmacy computing device 132, and pill dispenser computing device 118 communicate with one another using a cellular communication network at least on the initial network connection for the portable communication device and recognizes that portions of the communication between the device 108 and the server 102 may traverse various network forms, whether wired or wireless. In one aspect, the computing device 102, health care provider computing device 108, payer computing device 130, pharmacy computing device 132, and pill dispenser computing device 118 communicate with one another using any suitable protocol or messaging scheme. For example, they may communicate using a Hypertext Transfer Protocol (HTTP), extensible markup language (XML), extensible hypertext markup language (XHTML), or a Wireless Application Protocol (WAP) protocol. Other examples of communication protocols exist and may be employed by the present invention.

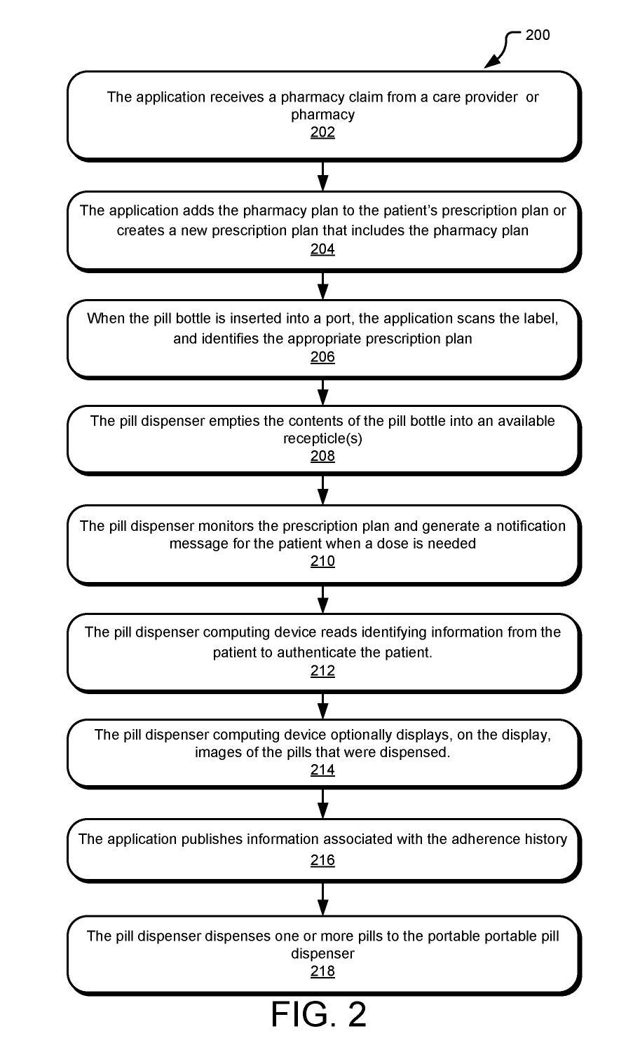

FIG. 2 illustrates an example process that is performed by the system 100 to manage dispensing of a prescription to a patient 112. A pharmacy claim is generated by a physician and submitted to a pharmacy management system or health information exchange. Additionally, the pharmacy fills the prescription in a standard pill bottle or a custom pill bottle or cartridge designed for a pill dispenser or directly into the portable pill dispenser. The cloud application will identify the patient using a combination of the patient name, data of birth, patient ID, address, and/or phone number (this is a standard identification model for a master patient index). After the patient is identified, the application will integrate the new prescription into the patient's existing (or new) prescription plan. The prescription plan will include all medications that are being managed by the cloud application and pill dispenser.

At step 204, the application receives a notification indicating that the patient has picked up their prescription from the pharmacy and stores the information in the pharmacy plan 142. That is, when the patient picks up their prescription, the claim is relayed from the pharmacy management system to the application. Existing pharmacy management systems are regularly reporting out pharmacy claims to external systems, so this approach fits into an existing operating model.

At step 206, when the pill bottle is inserted into a desired receptacle, the application may, using the prescription identification device 120, process information associated with the prescription 110. For example, the application 104 may acquire an image of the label, and perform the following actions: (i) maintain a copy of the label image for reference, (ii) read the barcode and identify the National Drug Code (NDC) to associate the bottle with the appropriate line in the prescription plan, (iii) identify the quantity in the pill bottle from the acquired pharmacy claim, and/or (iv) use optical character recognition to “read” the pill bottle label.

At step 208, the application updates the prescription plan 142 associated with the patient 112 and transmits a copy of the prescription plan 142 to the pill dispenser 116.

At step 210, the pill dispenser continually monitors the prescription plan and generates a notification message for the patient when a dose is needed. That is, on a configurable interval, the pill dispenser will check the prescription plan and identify if it is time for the patient to take their pill. If it is, the touchscreen display will illuminate with a message indicating what needs to be taken. Additionally, based on the notification rules, the patient will be telephoned, texted, emailed, and/or the dispenser will sound an audible alarm and/or display a visual alarm.

At step 212, the pill dispenser computing device 118 reads identifying information from the patient to authenticate the patient. That is, when the patient arrives at the pill dispenser, they will introduce their finger or other specified anatomical area (i.e. thumb, eye, etc.) on the biometric reader, and the pill dispenser will authenticate the user and dispense the appropriate pills.

At step 214, the pill dispenser computing device 118 optionally displays, on the display, images of the pills that were dispensed. Additionally, the pill dispenser computing device 118 may display on either or both of the display 124 of the pill dispenser computing device 118, or the display of a patient computing device 126, details about particular pills, such as anticipated side effects, special instructions, and general information about the drug. Also, either or both of the display 124 of the pill dispenser computing device 118, or the display of a patient computing device 126 may allow the patient to provide feedback through the system including feelings about the side-effects, costs, effectiveness, and the like. The pill dispenser computing device 118 records which pills were dispensed, and how many pills were dispensed from each receptacle 114, and when a minimum number of pills are determined, the pill dispenser computing device 118 may generate a reorder notification to the application 104 so that the prescription can be re-filled.

At step 216, the application 104 may publish information associated with the adherence history to any or each of the patient computing device 126, health care provider computing device 108, payer computing device 130, and/or pharmacy computing device 132. Thus, the care giver, payer, or pharmacy may view the patient's adherence history, and decide which medications to re-order and/or adjust the prescription plan accordingly.

At step 218, if the patient will be away from home for an extended period of time (e.g., leaves on a trip), the pill dispenser 116 can dispense one or more pills to the portable pill dispenser or pillbox 150. For example, before leaving for a vacation or any extended duration away from the home pill dispenser 116, the patient can load the portable pill dispenser 150 to the docking station 152, and a certain portion of each prescription stored in each receptacle 114 may be loaded into the portable pill dispenser 150. When the patient is using the portable pill dispenser, their personal device and mobile app running on that device will be used for the graphical interface, biometric reader, confirmation of pill and quantity taken, feedback, etc. that would otherwise have been provided by the dispenser. Additionally, the pill dispenser system will be able to be wirelessly paired with other vital sign measurement/monitoring devices to capture other useful health-related metrics that, when used, will be communicated to the systems cloud applications.

The steps described above may be repeated for management of other prescriptions. Nevertheless, when the use of the system 100 is no longer needed or desired, the process ends.

The description above includes example systems, methods, techniques, instruction sequences, and/or computer program products that embody techniques of the present disclosure. However, it is understood that the described disclosure may be practiced without these specific details.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., a hard disk drive), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

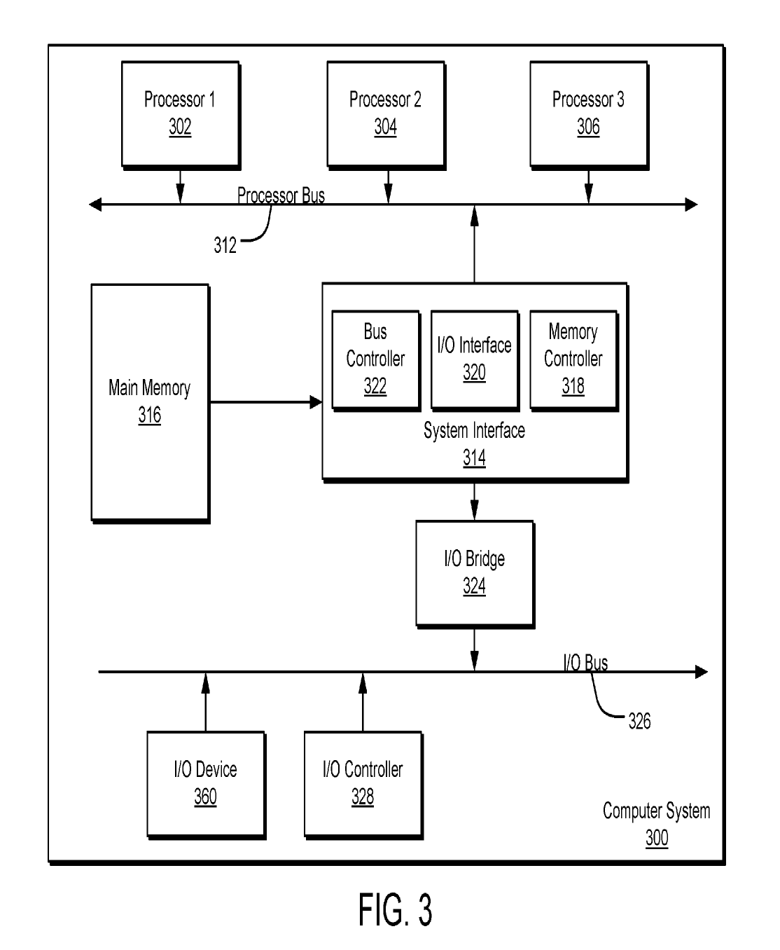

For example, FIG. 3 is a block diagram illustrating an example of a computing device or computer system 300 which may be used in implementing the embodiments of the present disclosure. The computer system (system) includes one or more processors 302-306. Processors 302-306 may include one or more internal levels of cache (not shown) and a bus controller or bus interface unit to direct interaction with the processor bus 312. Processor bus 312, also known as the host bus or the front side bus, may be used to couple the processors 302-306 with the system interface 314. System interface 314 may be connected to the processor bus 312 to interface other components of the system 300 with the processor bus 312. For example, system interface 314 may include a memory controller 313 for interfacing a main memory 316 with the processor bus 312. The main memory 316 typically includes one or more memory cards and a control circuit (not shown). System interface 314 may also include an input/output (I/O) interface 320 to interface one or more I/O bridges or I/O devices with the processor bus 312. One or more I/O controllers and/or I/O devices may be connected with the I/O bus 326, such as I/O controller 328 and I/O device 330, as illustrated.

I/O device 330 may also include an input device (not shown), such as an alphanumeric input device, including alphanumeric and other keys for communicating information and/or command selections to the processors 302-306. Another type of user input device includes cursor control, such as a mouse, a trackball, or cursor direction keys for communicating direction information and command selections to the processors 302-306 and for controlling cursor movement on the display device.

System 300 may include a dynamic storage device, referred to as main memory 316, or a random access memory (RAM) or other computer-readable devices coupled to the processor bus 312 for storing information and instructions to be executed by the processors 302-306. Main memory 316 also may be used for storing temporary variables or other intermediate information during execution of instructions by the processors 302-306. System 300 may include a read only memory (ROM) and/or other static storage device coupled to the processor bus 312 for storing static information and instructions for the processors 302-306. The system set forth in FIG. 3 is but one possible example of a computer system that may employ or be configured in accordance with aspects of the present disclosure.

According to one embodiment, the above techniques may be performed by computer system 300 in response to processor 304 executing one or more sequences of one or more instructions contained in main memory 316. These instructions may be read into main memory 316 from another machine-readable medium, such as a storage device. Execution of the sequences of instructions contained in main memory 316 may cause processors 302-306 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory 316. Common forms of machine-readable medium may include, but is not limited to, magnetic storage medium (e.g., hard disk drive); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

Embodiments of the present disclosure include various operations or steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A pill dispenser management system comprising:
a computing device comprising at least one processor and at least one memory to store instructions that are executed by the at least one processor to:
receive a pharmacy claim from a health care provider computing device, the pharmacy claim associated with a prescription to be fulfilled by a pharmacy for a patient;
process the received pharmacy claim to generate a pharmacy plan that includes information associated with the prescription; and
when prescription identifying information is received from a pill dispenser computing device of a pill dispenser, compare the prescription identifying information with the pharmacy plan to ensure that the prescription that is loaded in the pill dispenser is proper,
wherein the pill dispenser computing device of the pill dispenser monitors the prescription plan and generates a notification message to the patient when a dose of the prescription is needed for the patient.

2. The system of claim 1, wherein the instructions are further executed to configure the operation of the pill dispenser computing device through a communication network.

3. The system of claim 1, wherein the instructions are further executed to load a portable pill dispenser with a portion of one or more of the prescriptions stored in the pill dispenser.

4. The system of claim 3, wherein the portable pill dispenser includes a radio-frequency (RF) transceiver for communicating with a patient computing device for displaying information associated with the prescription on the patient computing device.

5. The system of claim 1, wherein the pill dispenser computing device is executed to obtain biometric information from the patient for authenticating the patient.

6. The system of claim 1, wherein the pill dispenser computing device is executed to display an image of the prescription on a display of the pill dispenser.

7. The system of claim 1, wherein the pill dispenser computing device is executed to obtain feedback information from the patient, and transmit the feedback information to the pill dispensing management system.

8. The system of claim 1, wherein the instructions are further executed to store an adherence score associated with the prescription in the memory, the adherence score comprising a degree to which the patient follows the prescription.

9. The system of claim 7, wherein the instructions are further executed to transmit the adherence score to at least one health care provider computing device of a health care provider, a payer computing device of a payer, a pharmaceutical company computing device of a pharmaceutical company or a pharmacy computing device of a pharmacy.

10. The system of claim 1, wherein the instructions are further executed to: receive one or more modifications to the prescription from a health care provider computing device or pharmaceutical company or designated representative managing a clinical trial for said pharmaceutical company, and transmit information associated with the modified prescription to the pill dispenser computing device, wherein the pill dispenser computing device modifies the prescription in according with the modified prescription.

11. The system of claim 1, wherein the pill dispenser computing device is executed to transmit a request to re-order another prescription to the system when the prescription goes below a specified threshold.

12. The system of claim 1, wherein the pill dispenser computing device is executed to obtain video information that shows the patient taking their medication, and transmit the video information to the system.

13. The system of claim 1, wherein the instructions are further executed to offer one or more rewards to the patient based on an adherence score of the patient.

14. The system of claim 1, wherein the instructions are further executed to consume a plurality of the pharmacy claims from a plurality of the pharmacy management systems and determine one or more demographic, behavioral, socioeconomic and health related criteria using one or more analytical tools to assess patient's adherence, relative adherence, significance of adherence and predictive analytics regarding expected adherence or other behaviors of patients.

15. The system of claim 1, wherein the instructions are further executed to make suggestions for the patient based on their medical condition.

16. The system of claim 1, wherein the pill dispenser computing device is further executed to automatically identify the prescription, and associate the contents with the pharmacy prescription.

17. The system of claim 1, wherein the instructions are further executed to form groups of patients who can communicate, with appropriate privacy, with one another to support and encourage medication adherence.

18. The system of claim 1, wherein the instructions are further executed to manage groups of the patients, via the patient computing device of each patient, to encourage in positive adherence behavior utilizing ramification and peer support concepts.

20. The system of claim 1, wherein the pill dispenser comprises a water dispenser to dispense water for the patient.

21. The system of claim 1, wherein the pill dispenser obtains medical information associated with the patient from one or more personal health devices via a radio-frequency transceiver.
